(19) United States
(12) Patent Application Publication
(10) Pub. No.: US 2012/0000430 A1
(43) Pub. Date: Jan. 5, 2012

(54) BARRIER STRUCTURE AND CONFINEMENT CRATE

(76) Inventor: Robert R. Rauch, Edina, MN (US)

(21) Appl. No.: 13/072,431

(22) Filed: Mar. 25, 2011

Related U.S. Application Data
(60) Provisional application No. 61/317,283, filed on Mar. 25, 2010.

(51) Int. Cl. A01K 1/00; A47D 13/06

(52) U.S. Cl. 119/416; 5/93.1

(57) ABSTRACT

A crate or barrier structure utilizes frames forming the sides of the crate or part of the barrier which include vertical or horizontal wires spaced apart from one another and extending codirectionally. Discrete structural design elements are welded, or otherwise fastened, to two or more of the wires, but not all, such that at least two of the wires are interconnected over a given one of the design elements. By placing a plurality of such design elements at various locations within a given one of the frames comprising the crate or barrier so as to interconnect different ones of the wires, enhanced support is provided without having to provide continuous wires crosswise to the vertical or horizontal wires.

### CROSS REFERENCE TO RELATED APPLICATIONS

This application claims the benefit of U.S. Provisional Application No. 61/317,283 filed Mar. 25, 2010 entitled PET CONFINEMENT CRATE.

### BACKGROUND OF THE INVENTION

The present invention relates to a confinement crate or containment barrier or system for children or pets, and more particularly to confinement crate or barrier structure which concomitantly provides structural strength and utility with pleasing aesthetics.

Conventional pet crates are generally comprised of frames each including vertical wires reinforced by a series of horizontal wire supports which are welded to the vertical wires, thereby maintaining spacing between the vertical wires so as to add stability to the frame, and inhibiting, for example, parallelograming. While such structural approach is effective functionally, the crate of such construction is not aesthetically pleasing.

Therefore, an object of the invention is to provide a barrier system or confinement crate which overcomes this and other drawbacks of the prior art.

### SUMMARY OF THE INVENTION

In accordance with these and other objects of the invention, an embodiment of the invention includes a wire frame structure which can serve as part of a confinement crate for pets or any type of pet or child barrier or other system for limiting access. The frames forming, for example, the sides of a crate, include vertical or horizontal wires (or like elongate members, extending either straight or in a wavy manner, etc.) spaced apart from one another and extending codirectionally. Discrete structural design elements are welded, or otherwise fastened, to two or more of the wires (or the like), but not to all, such that at least two of the wires are interconnected over a given one of the design elements. By placing a plurality of such design elements at various locations within a given one of the frames comprising the crate, or other containment system, so as to interconnect different ones of the wires, enhanced support is provided without having to provide continuous wires crosswise to the vertical or horizontal wires.

The design elements can be provided in any suitable form or of any material, but are advantageously formed of the same of similar material as the wires forming the frames. For example, by bending the wire material, shapes of hearts, flowers, leaves, butterflies, etc., can be formed for attachment to the spaced apart wires forming the frame panels.

The above, and other objects, features and advantages of the present invention will become apparent from the following description read in conjunction with the accompanying drawings.

### BRIEF DESCRIPTION OF THE DRAWINGS

FIG. 1 is perspective view of a conventionally produced crate;

FIG. 2 is plan view of a frame panel of a crate according to an embodiment of the invention utilizing flower design elements;

FIG. 3 plan view of a frame panel according to another embodiment of the invention utilizing heart design elements; and

FIG. 4 is a perspective view of a crate incorporating panels produced in general accordance with the embodiment of FIG. 3.

### DETAILED DESCRIPTION OF THE PREFERRED EMBODIMENT

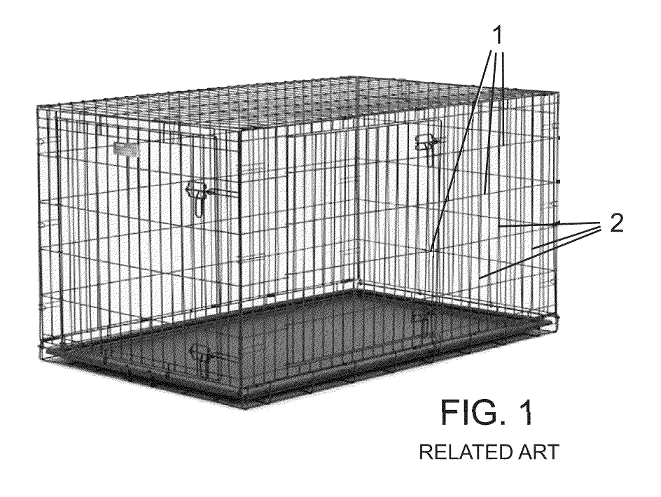

Referring now to the figures, FIG. 1 shows a conventional crate having a series of horizontal wires 1 which are welded to the vertical wires 2 of the frame side panels.

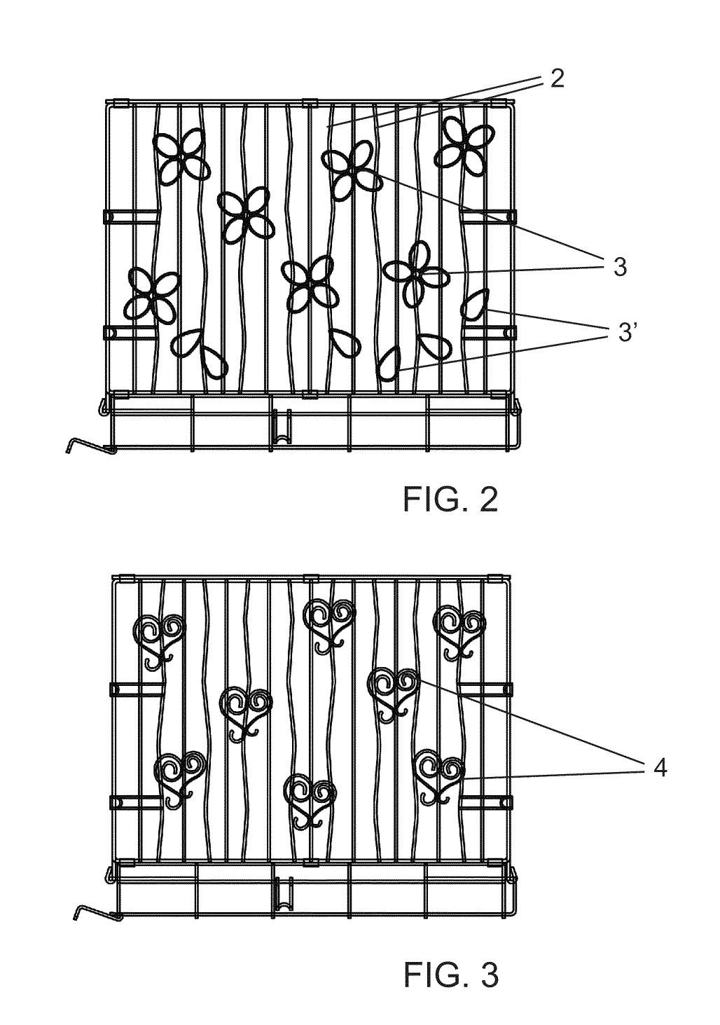

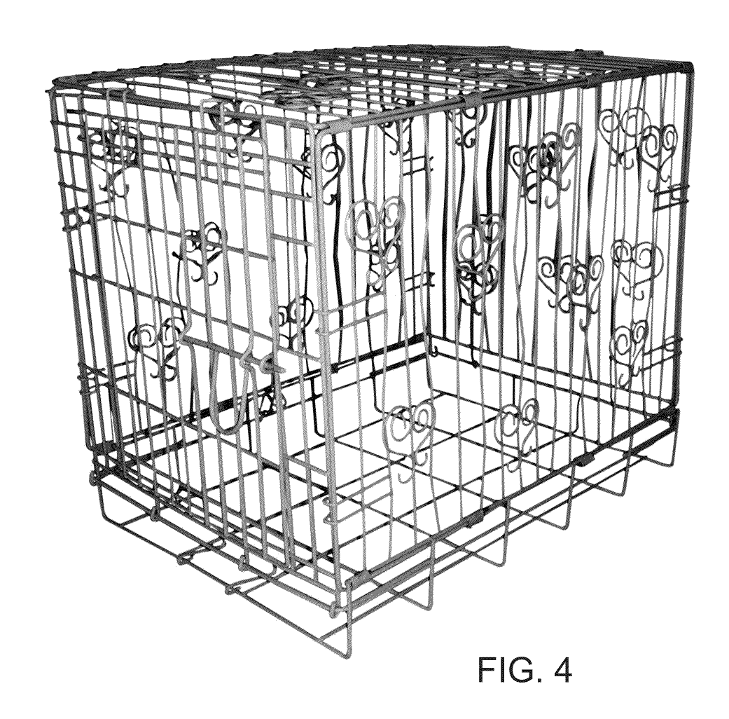

FIG. 2 depicts an embodiment in accordance with invention in which discrete design elements 3, in the form of flowers 3 (and separate petals 3′) are welded or fastened in suitable manner to ones of the vertical wires 2, so as to each interconnect at least two of the spaced apart vertical wires 2, but not all of the wires 2. As shown, to further enhance the charm of the crate panels, the vertical wires can optionally follow an uneven path (wavy).

FIG. 3 depicts a further example of design elements 4, in the form of stylized hearts, serving in function analogous with that of design elements 3 of FIG. 2.

While advantageously, all of the spaced apart wires 2 are each interconnected to at least another of the wires 2, such is not considered essential to the invention. For example, one of more of the wires can be left unattached to another of the wires without departure from the invention.

While the inventive panel components are shown in use as part of a crate, for positioning on any of the ends, sides, top, etc. thereof, it will be understood that the invention can be embodied as any form of confinement or barrier structure, or any other structure applicable to wire panels, without departure from the invention.

Any suitable material or construction method can be used to fabricate the panels. It is even conceivable that the entire panel could be molded as an integral unit such that the design elements and the elongated “wires” (i.e., elongated elements having the appearance of wire) would be part of an integrally molded structure. When the panels are fabricated of steel, the frames can be appropriately finished by powder coating or electro-coating, etc.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A confinement crate for an animal, comprising:
frame panels including a series of spaced apart, co-directionally disposed members; and
at least one discrete design element fastened between at least two of said members and remaining unattached to remaining ones of said members.

2. A panel for use in part of a confinement system for a child or animal, comprising:
a series of spaced apart, co-directionally disposed members; and
at least one discrete design element fastened between at least two of said members and remaining unattached to remaining ones of said members.
